(19) United States
(12) Patent Application Publication
(10) Pub. No.: US 2008/0241700 A1
(43) Pub. Date: Oct. 2, 2008

(54) Electrolyte for lithium rechargeable battery and lithium rechargeable battery comprising the same

(76) Inventors: Narae Park, Yongin-si (KR); Jinbum Kim, Yongin-si (KR); Jinsung Kim, Yongin-si (KR); Yongshik Kim, Yongin-si (KR)

Correspondence Address: ROBERT E. BUSHNELL, 1522 K STREET NW, SUITE 300, WASHINGTON, DC, 20005-1202, US

(21) Appl. No.: 12/078,056

(22) Filed: Mar. 26, 2008

(30) Foreign Application Priority Data
Mar. 28, 2007 (KR) 10-2007-0030166

(51) Int. Cl. H01M 6/16; H01M 10/40

(52) U.S. Cl. 429/330

(57) ABSTRACT

An electrolyte for the lithium rechargeable battery including non-aqueous organic solvent, fluoroethylene carbonate, and halogen-substituted benzene phenyl ether, and the lithium rechargeable battery comprising the same. The lithium rechargeable battery can improve the overcharging property of the increase of temperature and voltage when overcharging the lithium rechargeable battery. Additionally, the battery capacity retention ratio can be increased.

### CROSS-REFERENCE TO RELATED APPLICATION AND CLAIM OF PRIORITY

This application makes reference to, incorporates the same herein, and claims all benefits accruing under 35 U.S.C §119 from an application for Electrolyte for Lithium Rechargeable Battery and Lithium Rechargeable Battery Comprising The Same earlier field in the Korean Intellectual Property Office on Mar. 28, 2007 and there duly assigned Serial No. 10-2007-0030166.

### BACKGROUND

1. Field of the Invention

The present invention relates to an electrolyte for a lithium rechargeable battery and the lithium rechargeable battery comprising the same.

2. Description of the Related Art

Conventionally, a miniaturized and slimmed lithium rechargeable battery used for a cellular phone, an electronic scheduler, a wrist watch, etc. includes mixed lithium metal oxides as an anode active material, a carbon material or a lithium metal as a cathode active material, and an electrolyte dissolving a proper amount of lithium salts in an organic solvent.

More particularly, a typical and present electrolyte constitution element is a mixture of cyclic ester carbonate such as propylene carbonate (PC) and ethylene carbonate, chain ester carbonate such as dimethyl carbonate, methylethyl carbonate, diethyl carbonate, etc., and the mixture of cyclic ester carbonate and chain ester carbonate added to the solution of LiPF₆ is used.

Newly developed electrolyte materials are two types such as methylethyl carbonate (MEC) chosen in 1993 and methyl propionate used by a battery company after the lithium rechargeable battery is commercialized.

However, demands of the performance improvement of the battery, especially, an excellent charging and discharging performance have been recently increased, so a technology to add specific compounds to the electrolyte has been developed to fulfill it.

However, in case of adding specific compounds to the electrolyte to improve battery performance, there were problems that some items of battery performance can be improved, but the other items of battery performance may get worse. For example, if the additives are added to the electrolyte, low temperature performance is improved, but the performance of charging and discharging cycle is reduced.

### SUMMARY OF THE INVENTION

An object of the present invention is to provide an improved electrolyte for a lithium rechargeable battery.

An object of the present invention is to provide an electrolyte for a lithium rechargeable battery including non-aqueous organic solvent, lithium salts, fluoroethylene carbonate, halogen-substituted benzyl phenyl ether, and the lithium rechargeable battery comprising the same, thereby improving overcharging property by increasing temperature and voltage within the lithium rechargeable battery and maintaining a battery capacity according to charging and discharging cycle.

According to one aspect of the present invention, there is provided an electrolyte for the lithium rechargeable battery, which includes non-aqueous organic solvent, lithium salts, fluoroethylene carbonate, and halogen-substituted benzyl phenyl ether represented to the following chemical formula 1:

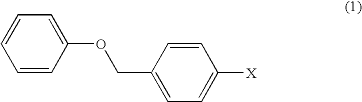

where X is F or Cl.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 is a graph illustrating the variation of the battery capacity according to the increase of charging/discharging cycle of a lithium rechargeable battery using an electrolyte according to an embodiment of the present invention;

FIG. 2 is a graph illustrating the variation of voltage and temperature at the time of overcharging according to the lapse of time of the lithium rechargeable battery using the electrolyte according to an embodiment of the present invention; and

FIG. 3 is a graph illustrating the variation of voltage and temperature at the time of overcharging in the comparative example carried out for a comparison of an electrolyte according to an embodiment of the present invention.

### DETAILED DESCRIPTION OF EXEMPLARY EMBODIMENTS

An electrolyte for the lithium rechargeable battery according to an embodiment of the present invention includes non-aqueous organic solvent, lithium salts, fluoroethylene carbonate, and halogen-substituted benzyl phenyl ether represented to the following chemical formula 1:

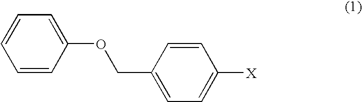

where X is F or Cl.

An added amount of the fluoroethylene carbonate may be in the range of 0.1 to 10 weight %, based on the total weight of the electrolyte.

An added amount of the halogen-substituted benzyl phenyl ether may be in the range of 1 to 10 weight %, based on the total weight of the electrolyte.

When the electrolyte having 0.1 to 10 weight % of fluoroethylene carbonate and 1 to 10 weight % of halogen-substituted benzyl phenyl ether is used, the capacity of the battery after 500 cycles is minutely decreased compared with the initial capacity. Therefore when halogen-substituted benzyl phenyl ether is added to electrolyte, the capacity of batteries may be maintained even though batteries are repeatedly charged/discharged.

The decomposition potential of the halogen-substituted benzyl phenyl ether may be 4.6 V.

The basic electrolyte may include non-aqueous organic solvent. The non-aqueous organic solvent may function as a medium that can transfer Li+ ions engaged in the electrochemical reaction of the battery.

Carbonate, ester, ether, ketone or its mixed one may be used as non-aqueous organic solvent. The organic solvent having a high dielectric constant (polarity) and a low viscosity is used to heighten the dissociation degree of ion and smoothen the ion conduction. In general, it is preferable to use the mixed solvent of at least two types comprised of a solvent having a high dielectric constant and a high viscosity and a solvent having a low dielectric constant and a low viscosity.

A cyclic carbonate and a chain carbonate may be used as the solvent of the carbonate group, and it is preferable to use both of the solvent by mixing. It is preferable to use the cyclic carbonate and the chain carbonate by mixing at a volume ratio of 1:1 to 1:9, more preferable to use the two solvents by mixing at a volume ratio of 1:1.5 to 1:4, in order to improve the electrolyte performance.

Ethylene carbonate (EC), propylene carbonate (PC), 1,2-butylene carbonate, 2,3-butylene carbonate, 1,2-pentylene carbonate, and 2,3-pentylene carbonate etc. may be used as the cyclic carbonate. It is preferable that ethylene carbonate and propylene carbonate having a high dielectric constant are used as the cyclic carbonate. The ethylene carbonate is preferably used where the artificial graphite is used as the cathode active material. Dimethyl carbonate (DMC), diethyl carbonate (DEC), dipropyl carbonate (DPC), methylpropyl carbonate (MPC), ethylmethyl carbonate (EMC), ethylpropyl carbonate (EPC), etc. may be used as the chain carbonate. It is preferable that dimethyl carbonate and ethylmethyl carbonate and diethyl carbonate which have a low viscosity are used as the chain carbonate.

The ester includes γ-butyrolactone (GBL), methyl acetate, ethyl acetate, propyl acetate, methyl propionate, ethyl propionate, γ-valerolactone, γ-caprolactone, δ-valerolactone, ε-caprolactone, etc. Preferably, tetrahydrofuran, 2-methyltetrahydrofuran, dibutyl ether, etc. may be used as the ester. Polymethylvinyl ketone, etc. may be used as the ketone.

The non-aqueous organic solvent may further include organic solvent of an aromatic hydrocarbon group, and it is preferable to mix it with carbonate organic solvent. The aromatic hydrocarbon compound group having the following chemical formula 2 may be used as organic solvent of the aromatic hydrocarbon group:

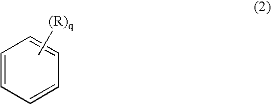

where R is halogen or alkyl with carbon number of 1 to 10, and q is an integral of 0 to 6.

As the specific example of the organic solvent of aromatic hydrocarbon, benzene, fluorobenzene, boromobenzene, chlorobenzene, toluene, xylene, and mesitylene, etc. may be used by itself or mixed ones. It is preferable that the volume ratio of carbonate solvent/organic solvent of aromatic hydrocarbon is in the range of 1:1 to 1:30 as an electrolyte including organic solvent of an aromatic hydrocarbon group. The electrolyte performance may be improved when mixed with the volume ratio.

The lithium salts may be one or more types selected from, but not limited to, the group consisting of LiPF₆, LiBF₄, LiSbF₆, LiAsF₆, LiClO₄, LiCF₃SO₃, LiN(SO₂CF₃)₂, LiC(SO₂C₂F₅)₂, LiN(SO₃CF₃)₂, LiC₄F₉SO₃, LiAlO₄, LiAlCl₄, LiCl and LiI.

The lithium rechargeable battery including the electrolyte may include an anode and a cathode.

The anode includes an anode active material that can intercalate and deintercalate lithium ion. It is preferable that the anode active material is a composite metal oxide of lithium and any one selected from cobalt, manganese, or nickel.

The ratio between metals may be varied, and any element selected from the group of Mg, Al, Co, K, Na, Ca, Si, Ti, Sn, V, Ge, Ga, B, As, Zr, Mn, Cr, Fe, Sr, V and rare earth elements may be further included.

The cathode includes a cathode active material that can intercalate and deintercalate lithium ion. Carbon material such as crystalline carbon, noncrystalline carbon, carbon composite, and carbon fiber, lithium metal and lithium alloy, etc. may be used as the cathode active material. For example, the noncrystalline carbon includes hard carbon, cokes, mesocarbon microbead (MCMB) fired below 1500° C., mesophase pitch-based carbon fiber (MPCF), etc. The crystalline carbon includes graphite material, particularly, natural graphite, graphitized cokes, graphitized MCMB, and graphitized MPMF, etc. It is preferable that the carbon material has an interplanar distance (d002) of 3.35-3.38 Å and crystallite size of at least 20 nm by X-ray diffraction. The alloy of lithium and aluminum, zinc, bismuth, cadmium, antimony, silicon, lead, tin, gallium or indium may be used as lithium alloy.

The anode or cathode may be made by dispersing an electrode active material, a binder, a conductive material, and a thickener if necessary, in a solvent, preparing electrode slurry compositions, and applying the slurry compositions to an electrode collector. Aluminum or aluminum alloy may be used as an anode collector, and copper or copper alloy may be used as a cathode collector. A foil, film, sheet, punched one, porous and foam body may be recited as a shape of the collectors of anode and cathode.

The binder is a substance to function pasting of an active material, mutual adhesion of active materials, adhesion with the collector, buffering effect for the shrinkage and swelling of an active material, etc. The binder includes polyvinylidene fluoride, copolymer(P(VdF/HFP)) of polyhexafluoropropylene-polyvinylidene fluoride, poly(vinyl acetate), polyvinyl alcohol, polyethylene oxide, polyvinylpyrrolidone, alkylated polyethylene oxide, polyvinyl ether, poly(methylmetacrylate), poly(ethylacrylate), polytetrafluoroethylene, polyvinylchloride, polyacrylonitrile, polyvinylpyridine, styrene-butadiene rubber, acrylonitrile-butadiene rubber, etc. The binder content is in the range of 0.1 to 30 weight %, preferably, 1 to 10 weight % based on the weight of an electrode active material. If the content of the binder is too little, adhesive strength between the electrode active material and the collector is not sufficient. If the content of the binder is too much, adhesive strength gets better, but it is unfavorable to make a battery having a high capacity because the content of the electrode active material reduces to that extent.

The conductive material is a substance improving conductivity of electrons. At least one selected from the group consisting of graphite, carbon black, metal or metal compounds may be used as the conductive material. There are artificial graphite and natural graphite, etc. as an example of graphite conductive material. There are acetylene black, ketjen black, denka black, thermal black, and channel black, etc. as an example of carbon black conductive material. There are tin, tin oxide, tin phosphate(SnPO₄), titanium oxide, potassium titanate and perovskite material such as LaSrCoO₃ and LaSrMnO₃, etc. as an example of conductive material of metal or metal composite, but not limited thereto. It is preferable that the content of conductive material is in the range of 0.1 to 10 weight %, based on the weight of the electrode active material. If the content of conductive material is less than 0.1 weight %, an electrochemical property is deteriorated, and if the content of conductive material is more than 10 weight %, an energy density per weight is reduced.

A type of the thickener is not specially limited if it can control the slurry viscosity of an active material. For example, carboxymethyl cellulose, hydroxymethyl cellulose, hydroxyethyl cellulose, hydroxypropyl cellulose, etc. may be used as the thickener.

Non-aqueous solvent or aqueous solvent is used as a dispersing solvent of an electrode active material, a binder and a conductive material, etc. There are N-methyl-2-pyrolidone (NMP), dimethylformamide, dimethylacetamide, N,N-dimethylaminopropylamine, ethylene oxide, tetrahydrofaran, etc. as non-aqueous solvent.

The lithium rechargeable battery may include a separator preventing an electrical short between the anode and the cathode, and providing a transfer passage of Li ions. Macromolecule membrane of polyolefin such as polypropylene, polyethylene, polyethylene/polypropylene, polyethylene/polypropylene/polyethylene, polypropylene/polyethylene/polypropylene, etc. or their multi-membrane, microporous film, woven fabric or nonwoven fabric may be used as the separator. A film coated on the porous polyolefin film by a polymer having superior stability may be also used as a separator.

The following examples illustrate the present invention in more detail. These examples, however, should not in any sense be interpreted as limiting the scope of the present invention.

### EXAMPLE 1

An anode slurry was prepared by mixing LiCoO2 as an anode active material, polyvinylidene fluoride (PVdF) as a binder, and carbon as a conductive material with a ratio of 92:4:4 weight %, then dispersing it in N-methyl-2-phyrolidone (NMP). The anode was made by drying and rolling it after coating the slurry on a aluminum foil of 20 μm thickness. A cathode slurry was prepared by mixing artificial graphite as the cathode active material, styrene-butadiene rubber as the binder, and carboxymethylcellulose as the thickener with a ratio of 96:2:2 weight %, then dispersing it in the water. The cathode was made by drying and rolling it after coating the slurry on a copper foil of 15 μm thickness. After inserting a film separator made of polyethylene of 20 μm thickness into the electrodes, winding, pressurizing, and inserting it into a can of angular type of 463450 size, a lithium rechargeable battery was made by inserting an electrolyte into the can of angular type. The electrolyte was prepared by adding 1M LiPF₆, 3 weight % of fluoroethylene carbonate, 1 weight % of fluorine-substituted benzyl phenyl ether to non-aqueous organic solvent of ethylene carbonate:ethylmethyl carbonate:dimethyl carbonate with a ratio of 1:1:1.

### EXAMPLE 2

This example was carried out by the same method as the example 1 except preparing the electrolyte by adding 2 weight % of fluorine-substituted benzyl phenyl ether in the example 1.

### EXAMPLE 3

This example was carried out by the same method as the example 1 except preparing the electrolyte by adding 3 weight % of fluorine-substituted benzyl phenyl ether in the example 1.

### EXAMPLE 4

This example was carried out by the same method as the example 1 except preparing the electrolyte by adding 10 weight % of fluorine-substituted benzyl phenyl ether in the example 1.

### EXAMPLE 5

This example was carried out by the same method as the example 1 except preparing the electrolyte by adding 12 weight % of fluorine-substituted benzyl phenyl ether in the example 1.

### EXAMPLE 6

This example was carried out by the same method as the example 1 except preparing the electrolyte by adding 1 weight % of chloride-substituted benzyl phenyl ether in the example 1.

### EXAMPLE 7

This example was carried out by the same method as the example 1 except preparing the electrolyte by adding 2 weight % of chloride-substituted benzyl phenyl ether in the example 1.

### EXAMPLE 8

This example was carried out by the same method as the example 1 except preparing the electrolyte by adding 3 weight % of chloride-substituted benzyl phenyl ether in the example 1.

### EXAMPLE 9

This example was carried out by the same method as the example 1 except preparing the electrolyte by adding 10 weight % of chloride-substituted benzyl phenyl ether in the example 1.

### EXAMPLE 10

This example was carried out by the same method as the example 1 except preparing the electrolyte by adding 12 weight % of chloride-substituted benzyl phenyl ether in the example 1.

### REFERENCE EXAMPLE

This example was carried out by the same method as the example 1 except preparing the electrolyte by adding 0.75 weight % of fluorine-substituted benzyl phenyl ether in the example 1.

### COMPARATIVE EXAMPLE

An anode slurry was prepared by mixing LiCoO2 as an anode active material, polyvinylidene fluoride (PVdF) as a binder, and carbon as a conductive material with a ratio of 92:4:4 weight %, then dispersing it in N-methyl-2-phyrolidon (NMP). The anode was made by drying and rolling it after coating the slurry on a aluminum foil of 20 μm thickness. The cathode slurry was prepared by mixing artificial graphite as a cathode active material, styrene-butadiene rubber as a binder, and carboxymethylcellulose as a thickener with a ratio of 96:2:2 weight %, then dispersing it in the water. The cathode was made by drying and rolling it after coating the slurry on a copper foil of 15 μm thickness. After inserting a film separator made of polyethylene(PE) with 20 μm thickness into the electrodes made above, winding, pressurizing, and inserting it into a can of angular type of 463450 size, a lithium rechargeable battery was made by inserting the electrolyte into the can of angular type. The electrolyte was prepared by adding 1M LiPF₆, 3 weight % of fluoroethylene carbonate in the basic electrolyte added by non-aqueous organic solvent of ethylene carbonate:ethylmethyl carbonate:dimethyl carbonate with a ratio of 1:1:1.

[Standard Capacity Test]

A standard capacity of the batteries made according to the examples, the reference example and the comparative example was measured after charging with static current and static voltage of 0.5 C/4.2V for 3 hours.

[Life Test]

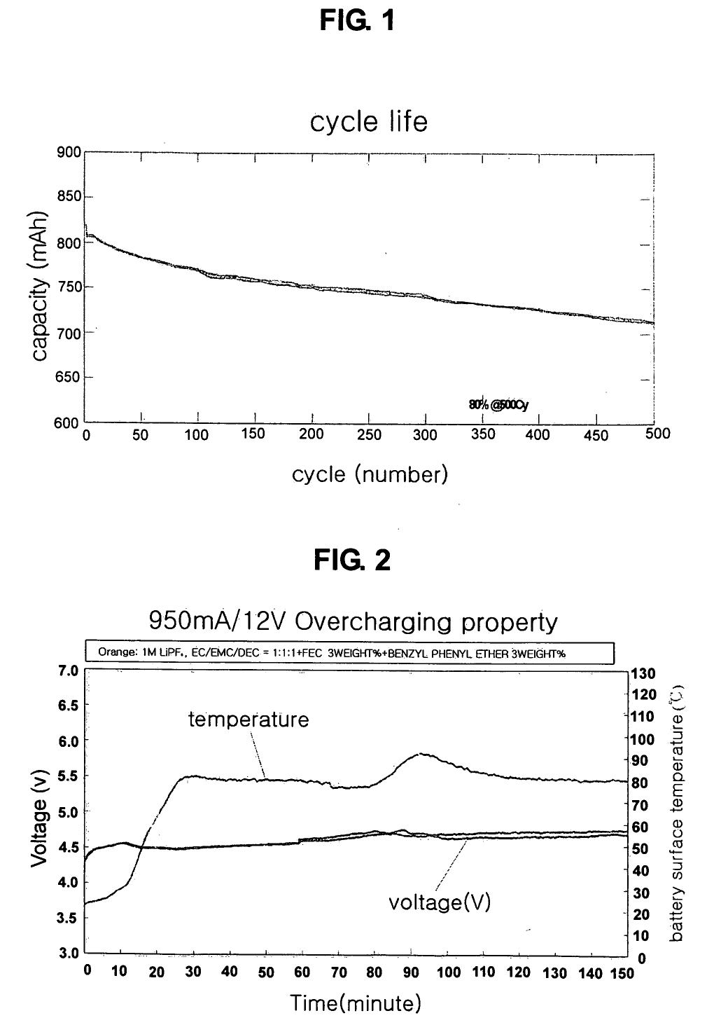

Discharge capacities at 500^{th} cycle of the batteries made according to the examples, the reference example and the comparative example were measured after charging with static current and static voltage of 0.5 C/4.2V for 3 hours and discharging with static current of 1 C/3 V. Retention ratios (%) at the 500^{th} cycle capacity of the batteries were calculated, and the results are illustrated in the following Table 1, and the variation of the battery capacity according to the increase of charging/discharging cycle of the battery of Example 3 is shown in FIG. 1.

A capacity retention ratio (%) at the 500^{th} cycle=(discharging capacity at 500th cycle/discharging capacity at 1st cycle)×100 (%)

[Overcharging Test]

A state of the batteries made according to the examples, the reference example and the comparative example was observed while charging with static current and static voltage of 1 C/12V for 2 and half hours after a standard charging at a normal temperature of 25° C. The test result was illustrated as NG (NOT GOOD) or OK. The overcharging stability of a lithium rechargeable battery can be classified as OK in case where there is no apparent change (L0), and there is leakage of electrolyte (L1), and as NG in case where high temperature, smoke, firing, or explosion at the battery takes place.

The test results of each standard capacity, capacity at the 500^{th} charging/discharging cycle, and the overcharging are illustrated in the following Table 1, FIG. 1 and FIG. 2.

TABLE 1

| | Standard | Capacity Retention | Overcharging |
|---|---|---|---|
| | capacity | ratio at 500th cycle | result |
| Example 1 | 100% | 90% | OK |
| Example 2 | 99% | 88% | OK |
| Example 3 | 99% | 85% | OK |
| Example 4 | 95% | 80% | OK |
| Example 5 | 89% | 74% | OK |
| Example 6 | 100% | 90% | OK |
| Example 7 | 99% | 88% | OK |
| Example 8 | 99% | 85% | OK |
| Example 9 | 95% | 80% | OK |
| Example 10 | 88% | 75% | OK |
| Reference | 100% | 100% | NG (Not Good) |
| Example | | | |
| Comparative | 100% | 100% | NG |
| Example | | | |

As the difference between the standard capacity and the 500^{th} charging/discharging cycle capacity of a lithium rechargeable battery using the electrolyte according to the embodiments of the present invention is in the range of 10 to 14% as shown in Table 1 and FIG. 1, there is no large difference between the capacity at the 500^{th} cycle and the initial capacity. The overcharging test of the examples according to the embodiments of the present invention turned out to be OK as there was no apparent change at the battery, but leakage of the electrolyte solution took place in some examples. With respect to the examples 5 and 10 and the reference example which included more than 10 weight % or less than 1 weight % of halogen-substituted benzyl phenyl ether, the standard capacity and the retention ratio were decreased (as shown in the examples 5 and 10), or the overcharging result was not good (as shown in the reference example), compared with the examples 1 through 10. The comparative example, which did not include halogen-substituted benzyl phenyl ether, can be classified as NG because high temperature, smoke, firing, or explosion took place.

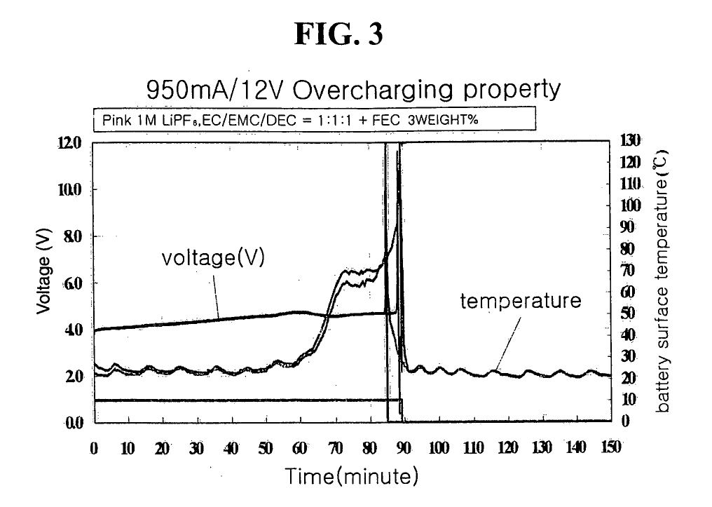

When observing the flow of temperature and voltage of Example 3 and the comparative example according to an embodiment of the present invention, the voltage was maintained constant with the time, but the temperature was increased rapidly after 20 to 30 minutes, and maintained constant until about 90 minutes, and increased again at about 100 minutes in Example 3 as shown in FIG. 2. On the other hand, the comparative example, which did not include halogen-substituted benzyl phenyl ether, showed that the voltage was rapidly increased at about 80 to 90 minutes, and decreased rapidly after 90 minutes as shown in FIG. 3.

When below 1 weight % of the halogen-substituted benzyl phenyl ether was added to the electrolyte, the standard capacity was well maintained, but the result of overcharging test showed NG. In addition, when more than 10 weight % of halogen-substituted benzyl phenyl ether was added to the electrolyte, the cycle life and standard capacity were decreased.

The lithium rechargeable battery using the electrolyte according to an embodiment of the present invention that includes non-aqueous organic solvent, fluoroethylene carbonate, and halogen-substituted benzyl phenyl ether improves the overcharging property due to the increase of temperature and voltage when overcharging the lithium rechargeable battery.

As described above, the lithium rechargeable battery using the electrolyte including non-aqueous organic solvent, lithium salts, fluoroethylene carbonate, and halogen-substituted benzyl phenyl ether can improve the overcharging property of the increase of temperature and voltage when overcharging the lithium rechargeable battery. The capacity retention ratio can be increased.

It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. An electrolyte for a lithium rechargeable battery, comprising:
non-aqueous organic solvent;
lithium salts;
fluoroethylene carbonate; and
halogen-substituted benzyl phenyl ether represented by Formula 1: 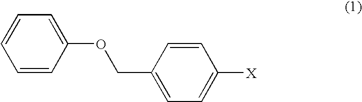
where X is F or Cl.

2. The electrolyte for the lithium rechargeable battery of claim 1, wherein an added amount of the fluoroethylene carbonate is in the range of 0.1 to 10 weight % based on the total weight of the electrolyte.

3. The electrolyte for the lithium rechargeable battery of claim 1, wherein an added amount of the halogen-substituted benzyl phenyl ether is in the range of 1 to 10 weight % based on the total weight of the electrolyte.

4. The electrolyte for the lithium rechargeable battery of claim 2, wherein a dissociation potential of the halogen-substituted benzyl phenyl ether is 4.6 V.

5. The electrolyte for the lithium rechargeable battery of claim 1, wherein the non-aqueous organic solvent is at least one selected from the group consisting of carbonate, ester, ether, and ketone.

6. The electrolyte for the lithium rechargeable battery of claim 5, wherein the carbonate is at least one solvent selected from the group consisting of dimethyl carbonate, diethyl carbonate, dipropyl carbonate, methylpropyl carbonate, ethylmethyl carbonate, ethylpropyl carbonate, ethylene carbonate, propylene carbonate, 1,2-butylene carbonate, 2,3-butylene carbonate, 1,2-pentylene carbonate and 2,3-pentylene carbonate.

7. The electrolyte for the lithium rechargeable battery of claim 1, wherein the lithium salts is one or more types selected from the group consisting of LiPF₆, LiBF₄, LiSbF₆, LiAsF₆, LiClO₄, LiCF₃SO₃, LiN(SO₂CF₃)₂, LiC(SO₂C₂F₅)₂, LiN(SO₃CF₃)₂, LiC₄F₉SO₃, LiAlO₄, LiAlCl₄, LiCl and LiI.

8. The electrolyte for the lithium rechargeable battery of claim 1, wherein X in the Formula 1 is F.

9. The electrolyte for the lithium rechargeable battery of claim 1, wherein X in the Formula 1 is Cl.

10. An electrolyte for a lithium rechargeable battery, comprising:
non-aqueous organic solvent;
lithium salts;
fluoroethylene carbonate in the range of 0.1 to 10 weight % based on the total weight of the electrolyte; and
halogen-substituted benzyl phenyl ether represented by Formula 1: 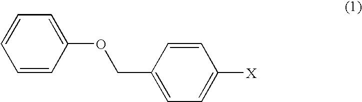
where X is F or Cl, and an amount of the halogen-substituted benzyl phenyl ether is in the range of 1 to 10 weight % based on the total weight of the electrolyte.

11. A lithium rechargeable battery comprising:
an electrolyte comprising:
non-aqueous organic solvent;
lithium salts;
fluoroethylene carbonate; and
halogen-substituted benzyl phenyl ether represented by Formula 1: 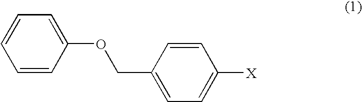
where X is F or Cl;
an anode comprising an anode active material capable of intercalating and deintercalating Li ions reversibly; and
a cathode comprising a cathode active material capable of intercalating and deintercalating Li ions reversibly.

12. The lithium rechargeable battery of claim 11, wherein an added amount of the fluoroethylene carbonate is in the range of 0.1 to 10 weight % based on the total weight of the electrolyte.

13. The lithium rechargeable battery of claim 11, wherein an added amount of the halogen-substituted benzyl phenyl ether is in the range of 1 to 10 weight % based on the total weight of the electrolyte.

14. The lithium rechargeable battery of claim 11, wherein the non-aqueous organic solvent is at least one selected from the group consisting of carbonate, ester, ether, and ketone.

15. The lithium rechargeable battery of claim 11, wherein the non-aqueous organic solvent comprises carbonate and organic solvent of an aromatic hydrocarbon group represented by Formula 2: 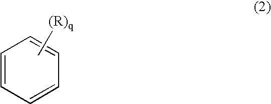
where R is halogen or alkyl with carbon number of 1 to 10, and q is an integral of 0 to 6.

16. The lithium rechargeable battery of claim 11, wherein the lithium salts is one or more types selected from the group consisting of LiPF₆, LiBF₄, LiSbF₆, LiAsF₆, LiClO₄, LiCF₃SO₃, LiN(SO₂CF₃)₂, LiC(SO₂C₂F₅)₂, LiN(SO₃CF₃)₂, LiC₄F₉SO₃, LiAlO₄, LiAlCl₄, LiCl and LiI.

17. The lithium rechargeable battery of claim 11, wherein X in the Formula 1 is F.

18. The lithium rechargeable battery of claim 11, wherein X in the Formula 1 is Cl.

19. The lithium rechargeable battery of claim 11, wherein an added amount of the fluoroethylene carbonate is in the range of 0.1 to 10 weight % based on the total weight of the electrolyte, and an added amount of the halogen-substituted benzyl phenyl ether is in the range of 1 to 10 weight % based on the total weight of the electrolyte.
